(19) United States
(12) Patent Application Publication
(10) Pub. No.: US 2026/0300398 A1
(43) Pub. Date: Oct. 1, 2026

(54) ONTOLOGY MAPPING USING DIRECTED PROPERTY GRAPHS

(71) Applicant: Infosys Limited, Bangalore (IN)

(72) Inventors: Steven SCHILDERS, Indianapolis, IN (US); Chitra THEAGARAJAN, Bengaluru (IN)

(73) Assignee: Infosys Limited, Bangalore, KA (IN)

(21) Appl. No.: 19/094,764

(22) Filed: Mar. 28, 2025

(51) Int. Cl. G06F 16/901

(52) U.S. Cl. CPC G06F 16/9024

(57) ABSTRACT

An efficient and secure ontology mapping is disclosed. Primary and auxiliary graphs (e.g., directed property graphs) with unique ontologies are generated. The primary graph comprises primary nodes and mapper nodes, whereas the auxiliary graph comprises auxiliary nodes. The mapper nodes map the primary nodes to the auxiliary nodes, with each mapper node storing rules that define the mapping between auxiliary and primary nodes. In operation, a stimulus indicative of data values associated with the auxiliary graph is received. Based on the stimulus, using the auxiliary graph, auxiliary nodes associated with the data values are identified. Further, using the primary graph, mapper nodes linked to the auxiliary nodes, and in turn, primary nodes linked to the mapper nodes are identified. Based on the data values, the mapper nodes, and the primary nodes, an operation associated with the stimulus is executed.

### FIELD OF THE DISCLOSURE

Various embodiments of the present disclosure relate generally to directed property graphs. More specifically, various embodiments of the present disclosure relate to ontology mapping using directed property graphs.

### BACKGROUND

Information technology has become indispensable across various domains, including healthcare, finance, robotics, and business. Artificial intelligence and machine learning, fundamental pillars of modern information technology, drive efficiency by enabling digitization and automation of complex operations. As these domains continue to adopt advanced and cutting-edge technologies, seamless integration and optimization of digital processes are required to maintain competitive performance. Many operations now require real-time execution, necessitating equally real-time digitization and automation. These processes often involve retrieving, transforming, and visualizing data from diverse sources, each structured using different database schemas. Thus, for efficient and accurate real-time operations, there is a need to establish interoperability between different data sources.

In light of the foregoing, there exists a need for a technical and reliable solution that overcomes the abovementioned problems.

Limitations and disadvantages of conventional and traditional approaches will become apparent to one of skill in the art, through the comparison of described systems with some aspects of the present disclosure, as set forth in the remainder of the present application and with reference to the drawings.

### SUMMARY

Methods and systems for facilitating ontology mapping using directed property graphs are provided substantially as shown in, and described in connection with, at least one of the figures.

In an embodiment of the present disclosure, a system is disclosed. The system comprises storage circuitry configured to store a primary graph and an auxiliary graph. The primary graph comprises a plurality of primary nodes and a plurality of mapper nodes. The auxiliary graph comprises a plurality of auxiliary nodes. The plurality of mapper nodes is configured to map the plurality of primary nodes and the plurality of auxiliary nodes such that each mapper node is configured to store a set of rules that define mapping of one or more auxiliary nodes to at least one primary node. The system further comprises processing circuitry that is coupled to the storage circuitry. The processing circuitry is configured to receive a stimulus indicative of a set of data values associated with the auxiliary graph. Based on the stimulus, the processing circuitry is further configured to identify, using the auxiliary graph, a set of auxiliary nodes associated with the set of data values. Using the primary graph, the processing circuitry is further configured to identify one or more mapper nodes linked to the set of auxiliary nodes. Further, using the primary graph, the processing circuitry is configured to identify a set of primary nodes. Each mapper node of the one or more mapper nodes is linked to at least one of the set of primary nodes. Based on at least one of the set of data values, the one or more mapper nodes, or the set of primary nodes, the processing circuitry is further configured to execute an operation associated with the stimulus.

In some embodiments, each of the primary graph and the auxiliary graph has a unique ontology. The mapping between the plurality of primary nodes and the plurality of auxiliary nodes corresponds to an ontology mapping between the primary graph and the auxiliary graph.

In some embodiments, to execute the operation associated with the stimulus, the processing circuitry is further configured to generate an outcome graph based on at least one of the set of data values, the one or more mapper nodes, or the set of primary nodes.

In some embodiments, the processing circuitry is further configured to store the outcome graph in the storage circuitry.

In some embodiments, the outcome graph comprises one or more outcome nodes that represent the set of data values in conformity with an ontology associated with the primary graph.

In some embodiments, each auxiliary node of the set of auxiliary nodes has a data value of the set of data values associated therewith, and is linked to a mapper node of the one or more mapper nodes. The mapper node maps the corresponding auxiliary node, of the set of auxiliary nodes, to at least one primary node of the set of primary nodes.

In some embodiments, the outcome graph corresponds to a directed property graph.

In some embodiments, to generate the outcome graph, the processing circuitry is further configured to create a set of outcome nodes based on the set of primary nodes, execute the set of rules associated with each of the one or more mapper nodes on a data value associated with an auxiliary node, of the set of auxiliary nodes, linked to the corresponding mapper node, generate another set of data values based on the execution of the set of rules associated with each of the one or more mapper nodes, and populate the set of outcome nodes based on the other set of data values.

In some embodiments, a data value, of the other set of data values, is generated based on one or more data values, of the set of data values.

In some embodiments, the set of outcome nodes matches the set of primary nodes.

In some embodiments, at least one primary node, of the set of primary nodes, is represented as node properties of an outcome node, of the set of outcome nodes.

In some embodiments, at least a first primary node, of the set of primary nodes, is absent in the set of outcome nodes.

In some embodiments, one or more primary nodes, of the set of primary nodes, are linked to the first primary node, a second primary node, of the set of primary nodes, extends the first primary node. The set of outcome nodes comprises (i) one or more outcome nodes that match the one or more primary nodes, respectively, and (ii) an outcome node that matches the second primary node. The absence of the first primary node in the set of outcome nodes results in the one or more outcome nodes being linked to the outcome node.

In some embodiments, the one or more mapper nodes are linked to the set of auxiliary nodes by way of one or more edges, respectively. Each mapper node of the one or more mapper nodes is linked to at least one of the set of primary nodes by way of an edge.

In some embodiments, the set of primary nodes comprises a first primary data node. The set of auxiliary nodes comprises a first auxiliary data node. The one or more mapper nodes comprise a first mapper node that is configured to store a first set of rules that define mapping of the first auxiliary data node to the first primary data node.

In some embodiments, the set of primary nodes further comprises a second primary data node that extends the first primary data node. The set of auxiliary nodes further comprises a second auxiliary data node that extends the first auxiliary data node. The one or more mapper nodes further comprise a second mapper node that is configured to store a second set of rules that define mapping of the second auxiliary data node to the second primary data node. The second mapper node extends the first mapper node.

In some embodiments, the set of primary nodes further comprises a first primary attribute node, with the first primary data node being associated with the first primary attribute node that represents a first primary attribute of the first primary data node. The set of auxiliary nodes further comprises a first auxiliary attribute node, with the first auxiliary data node being associated with the first auxiliary attribute node that represents a first auxiliary attribute of the first auxiliary data node. The one or more mapper nodes further comprise a third mapper node that is configured to store a third set of rules that define mapping of the first auxiliary attribute node to the first primary attribute node.

In some embodiments, each of the primary graph and the auxiliary graph corresponds to a directed property graph.

In some embodiments, the primary graph and the auxiliary graph constitute a directed property graph.

In some embodiments, the processing circuitry is further configured to (i) generate the primary graph and the auxiliary graph and (ii) store the primary graph and the auxiliary graph in the storage circuitry. To generate the auxiliary graph, the processing circuitry is further configured to create the plurality of auxiliary nodes. To generate the primary graph, the processing circuitry is further configured to create the plurality of primary nodes and the plurality of mapper nodes. The processing circuitry is further configured to link the plurality of primary nodes, the plurality of mapper nodes, and the plurality of auxiliary nodes by way of a plurality of edges.

In some embodiments, the processing circuitry is further configured to determine, for each mapper node of the plurality of mapper nodes, one or more mapping attributes that indicate the one or more auxiliary nodes that are linked to the corresponding mapper node. The processing circuitry is further configured to associate the one or more mapping attributes as node properties of the corresponding mapper node.

In some embodiments, the processing circuitry is further configured to determine, for a node, an abstract attribute indicative of an abstraction status of the corresponding node. The node corresponds to one of (i) a primary node of the plurality of primary nodes and (ii) an auxiliary node of the plurality of auxiliary nodes. The processing circuitry is further configured to associate the abstract attribute as node properties of the corresponding node.

In another embodiment of the present disclosure, a method is disclosed. The method comprises receiving, by processing circuitry, a stimulus. A primary graph comprises a plurality of primary nodes and a plurality of mapper nodes. An auxiliary graph comprises a plurality of auxiliary nodes. The plurality of primary nodes and the plurality of auxiliary nodes are mapped by way of the plurality of mapper nodes such that a set of rules stored in each mapper node, of the plurality of mapper nodes, define mapping of one or more auxiliary nodes, of the plurality of auxiliary nodes, to at least one primary node, of the plurality of primary nodes. The stimulus is indicative of a set of data values associated with the auxiliary graph. The method further comprises identifying, by the processing circuitry, based on the stimulus, using the auxiliary graph, a set of auxiliary nodes associated with the set of data values. The method further comprises identifying, by the processing circuitry, using the primary graph, one or more mapper nodes linked to the set of auxiliary nodes. Further, the method comprises identifying, by the processing circuitry, using the primary graph, a set of primary nodes. Each mapper node of the one or more mapper nodes is linked to at least one of the set of primary nodes. The method further comprises executing, by the processing circuitry, an operation associated with the stimulus based on at least one of the set of data values, the one or more mapper nodes, or the set of primary nodes.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

Embodiments of the present disclosure are illustrated by way of example and are not limited by the accompanying figures. Similar references in the figures may indicate similar elements. Elements in the figures are illustrated for simplicity and clarity and have not necessarily been drawn to scale.

FIG. 1 is a block diagram that illustrates a system environment for ontology mapping using directed property graphs, consistent with disclosed embodiments of the present disclosure;

FIG. 2A is a schematic diagram that illustrates ontology mapping between a primary graph and an auxiliary graph, consistent with disclosed embodiments of the present disclosure;

FIG. 2B is a schematic diagram that illustrates an outcome graph, consistent with disclosed embodiments of the present disclosure;

FIG. 2C is a schematic diagram that illustrates another outcome graph, consistent with disclosed embodiments of the present disclosure;

FIGS. 3A and 3B are schematic diagrams that, collectively, represent an example implementation of ontology mapping using directed property graphs, consistent with disclosed embodiments of the present disclosure;

FIGS. 4A and 4B, collectively, represent a flowchart that illustrates a method for facilitating ontology mapping using directed property graphs, consistent with disclosed embodiments of the present disclosure; and

FIG. 5 illustrates an example computing system for carrying out the methods of the present disclosure, consistent with disclosed embodiments of the present disclosure.

### DETAILED DESCRIPTION

The detailed description of the appended drawings is intended as a description of the embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

### Overview

Traditionally, interoperability between data sources with different database schemas (e.g., ontologies) is achieved through mapping techniques. A database schema or ontology defines the structural framework of a data source, outlining data organization, relationships, and constraints. When multiple data sources have unique ontologies, their alignment is known as ontology mapping, typically performed using third-party mapper applications. However, relying on third-party mappers introduces several challenges. For example, these mapper applications require data to be duplicated and provided externally, leading to inefficient storage utilization. More critically, sensitive and confidential data may be exposed to security vulnerabilities when shared with third-party applications, posing significant data security threats. Additionally, the different data sources are typically stored in separate systems. Thus, the retrieval of required data based on the ontology mapping involves significant latencies that may prove to be fatal in areas such as healthcare. The increased latency may lead to undesirable outcomes during real-time operations.

The present disclosure provides a different approach for efficient and secure ontology mapping. The present disclosure discloses graphs (e.g., directed property graphs) generated for various data schemas (e.g., ontologies) associated with a real-time system. For example, the present disclosure discloses a primary graph and an auxiliary graph, with each graph corresponding to a unique ontology. Each graph may include various data and attribute nodes. The data nodes may represent data values of a corresponding dataset. Various attribute nodes may be associated with a data node, and may represent attributes of the corresponding data node. The primary graph may further include mapper nodes. To enable interoperability between the primary and auxiliary graphs, the two graphs may be mapped to each other based on the mapper nodes. Each mapper node includes one or more rules based on which the corresponding primary graph and the associated auxiliary graph are mapped to each other. Each mapper node may further include metadata associated with the nodes of the auxiliary graph to which it is mapped.

In operation, a stimulus associated with the real-time system is received. The stimulus may be generated to map data values from a dataset associated with the auxiliary graph to the dataset associated with the primary graph. Based on the stimulus, one or more nodes of the auxiliary graph are identified. Further, mapper nodes associated with each identified auxiliary node are identified, and in turn, primary nodes are identified. Based on the identified mapper nodes, the auxiliary nodes, and the primary nodes, a new outcome graph is generated. The outcome graph may be generated based on the execution of mapper rules associated with the mapper nodes. The outcome graph corresponds to the inclusion of data values associated with the auxiliary graph stored in accordance with the schema of the primary graph. The translation of the data values associated with the auxiliary graph to the schema of the primary graph may be based on the business rules of the real-time system.

The traditional approach of ontology mapping involves mapping between the ontologies by third-party mapper applications. As the data that is to be mapped is provided to the mapper applications, the data to be mapped is duplicated and leads to inefficient use of storage resources. Additionally, the data accessible to third-party mapper applications compromises the data, rendering it vulnerable to security threats. The primary and auxiliary graphs of the present disclosure are secured from security threats as they are not exposed to any third-party mapper applications. Also, ontology mapping between primary and auxiliary graphs and retrieval of the required data based on the ontology mapping involves significantly reduced latency. It is appreciated that the human mind is not equipped to conceptualize an optimized mapping between multiple different ontologies, given the digital interconnectedness of the ontology mapping.

### Figure Description

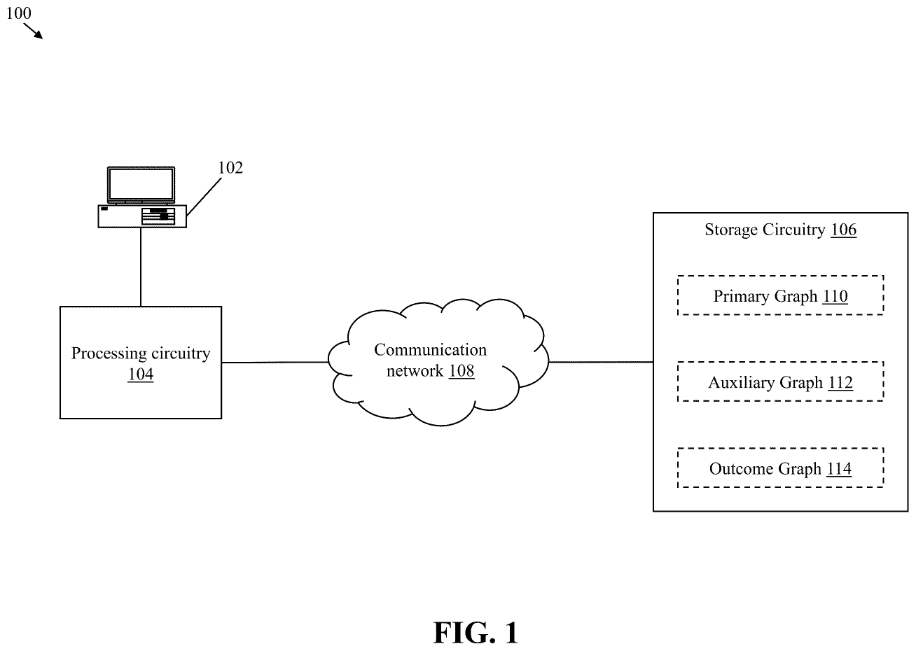

FIG. 1 is a block diagram that illustrates a system environment 100 for ontology mapping using directed property graphs, consistent with disclosed embodiments of the present disclosure. In today's fast-paced world, domains such as artificial intelligence (AI), healthcare, and internet of things (IoT) are rapidly advancing, with their respective subdomains undergoing increasing digitalization. Each subdomain may function as a distinct data source, derived from a specific dataset that structures information based on the intended focus. For instance, within the healthcare domain, multiple subdomains—such as medical diagnosis and diseases, patient data and electronic health records (EHR), and hospital and healthcare management—serve different purposes. For example, medical diagnosis and diseases focus on diseases, diagnoses, and symptoms, whereas patient data and EHR centers around patient records, medical history, and reports. Further, hospital and healthcare management manages administrative data, including appointments, billing, and hospital visits. Each of these subdomains represents and structures data differently, aligning with an ontology that defines its underlying concepts, relationships, and semantics. For example, the representation of a patient may vary across these subdomains, depending on the dataset and ontology in use. However, executing operations across multiple subdomains may necessitate interoperability, enabling seamless communication and data exchange between them. This interoperability may be facilitated through ontology mapping, ensuring that different subdomains can understand and process shared data meaningfully.

Traditionally, the ontology mapping is performed using third-party mapper applications. However, relying on third-party mappers introduces several challenges. For example, these mapper applications require data to be duplicated and provided externally, leading to inefficient storage utilization. More critically, sensitive and confidential data may be exposed to security vulnerabilities when shared with third-party applications, posing significant data security threats. Additionally, the different data sources are typically stored in separate systems. Thus, the retrieval of required data based on the ontology mapping involves significant latencies that may prove to be fatal in areas such as healthcare. The increased latency may lead to undesirable outcomes during real-time operations.

The present disclosure provides a solution to implement efficient and secure ontology mapping in directed property graphs. A directed property graph is a graph data model consisting of nodes, edges, and properties, where edges have direction and both nodes and edges can store key-value pairs, allowing for complex data representation and efficient querying. Referring to FIG. 1, the system environment 100 may include a real-time system 102, processing circuitry 104, storage circuitry 106, and a communication network 108. Examples of the storage circuitry 106 may include, but are not limited to, a random-access memory (RAM), a read-only memory (ROM), a removable storage drive, a hard disk drive (HDD), a flash memory, a solid-state memory, or the like. The processing circuitry 104 is configured to access the storage circuitry 106 via the communication network 108.

The real-time system 102 may represent a distributed platform that may encompass various services associated with domains like healthcare, finance, AI, or the like. Each of these services may be associated with various business rules. Further, each of these domains may be associated with various data sources, each following a unique ontology for representation of the data associated therewith. The business rules associated with various services of the domain may require the various data sources to interoperate with each other for executing various operations associated therewith. Therefore, efficient and secure ontology mapping may be required for efficient decision-making based on the execution of various operations thereof.

The processing circuitry 104 may include suitable logic, circuitry, interfaces, and/or code, executable by the circuitry, that may be configured to perform optimized and secure ontology mapping. The processing circuitry 104 may be configured to generate a primary graph 110 and an auxiliary graph 112. Each of the primary graph 110 and the auxiliary graph 112 may have a unique ontology associated therewith. That is to say, the ontology of the primary graph 110 may be different from the ontology of the auxiliary graph 112.

### Generation of Primary and Auxiliary Graphs 110 and 112

Each of the primary and auxiliary graphs 110 and 112 may correspond to a directed property graph. To generate the primary graph 110, the processing circuitry 104 may be further configured to create a plurality of primary nodes and a plurality of mapper nodes. Similarly, to generate the auxiliary graph 112, the processing circuitry 104 may be further configured to create a plurality of auxiliary nodes. The plurality of primary nodes may represent a plurality of data values associated with the primary graph 110. Further, the plurality of mapper nodes may be configured to map the plurality of primary nodes and the plurality of auxiliary nodes such that each mapper node is configured to store a set of rules that define mapping of one or more auxiliary nodes to at least one primary node. Further, each mapper node may be linked to one or more primary nodes by way of one or more edges, respectively.

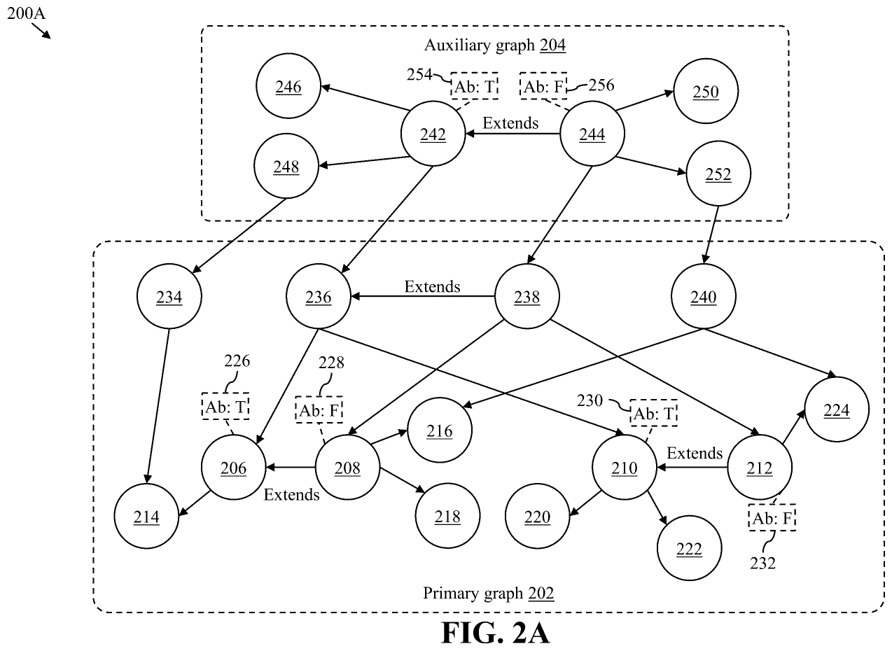

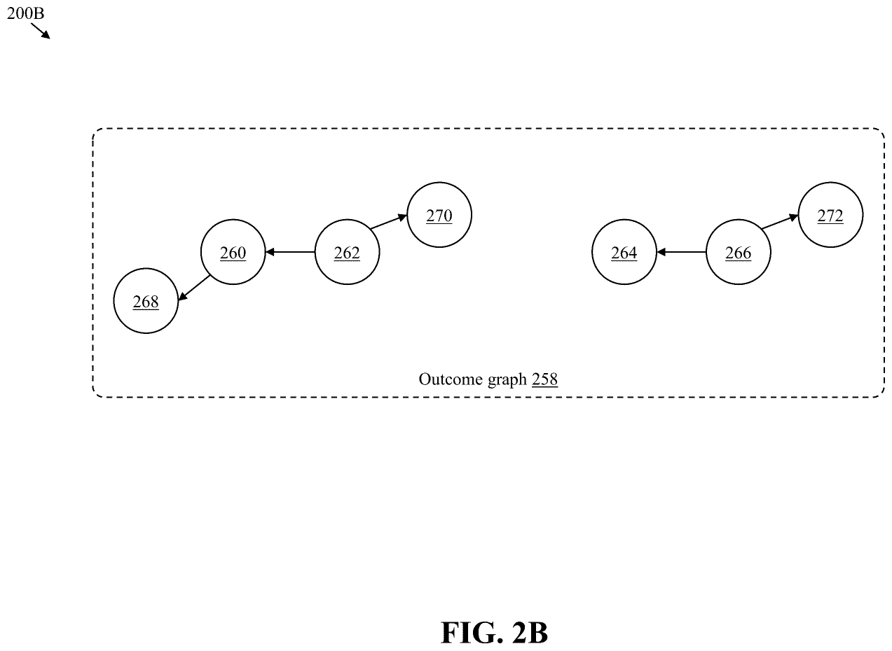

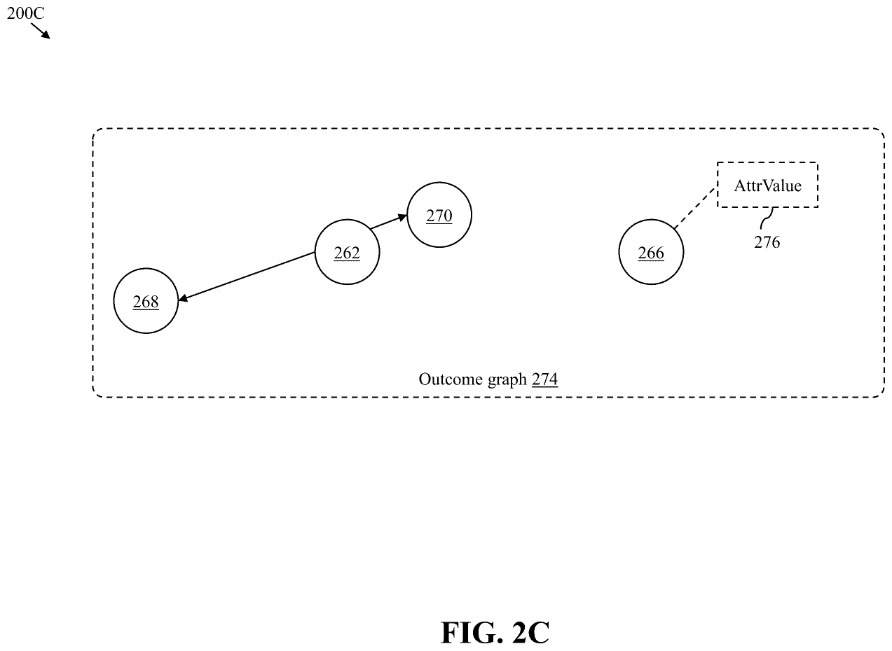

The primary graph 110 may correspond to a standardized graph derived for a domain. Further, the primary graph 110 may be associated with a corresponding schema, i.e., an ontology. The ontology of the primary graph 110 may be based on ontologies of various subdomains within the domain for which the primary graph 110 is generated. That is to say, for each data value associated with an ontology of a subdomain, the primary graph 110 may comprise an equivalent primary node, representing the data value in the ontology of the subdomain. The mapping between the data value in the ontology of the subdomain to the primary node in the primary graph 110 is facilitated by way of the one or more mapper nodes. The structure of the primary graph 110 is explained in detail in FIG. 2A.

The auxiliary graph 112 may correspond to a graph derived for a subdomain associated with the domain of the primary graph 110. Further, the auxiliary graph 112 may be associated with a corresponding schema, i.e., an ontology. The ontology of the auxiliary graph 112 may be based on the ontology of the subdomain. The processing circuitry 104 may be further configured to link the plurality of primary nodes, the plurality of mapper nodes, and the plurality of auxiliary nodes by way of a plurality of edges. The structure of the auxiliary graph 112 is explained in detail in FIG. 2A.

Thus, the primary graph 110 and the auxiliary graph 112 may be mapped based on the schemas associated therewith. Ontology mapping realized in this manner may further facilitate execution of a stimulus that may require real-time ontology mapping for the execution thereof.

For example, using the primary graph 110 and the auxiliary graph 112, the processing circuitry 104 may be further configured to generate (e.g., derive) an outcome graph 114 based on various business rules associated with the real-time system 102. The outcome graph 114 may be a directed property graph. The processing circuitry 104 may be further configured to store the outcome graph 114 in the storage circuitry 106.

### Generation of the Outcome Graph 114

The processing circuitry 104 may be configured to receive a stimulus. The stimulus may be indicative of a set of data values associated with the auxiliary graph 112. Based on the stimulus, the processing circuitry 104 may be configured to identify, using the auxiliary graph 112, a set of auxiliary nodes associated with the set of data values. Further, the processing circuitry 104 may be configured to identify, using the primary graph 110, one or more mapper nodes linked to the set of auxiliary nodes. The processing circuitry 104 may be further configured to identify, using the primary graph 110, a set of primary nodes. Further, the processing circuitry 104 may be configured to execute an operation associated with the stimulus based on at least one of the set of data values, the one or more mapper nodes, or the set of primary nodes.

To execute the operation, the processing circuitry 104 may be further configured to generate the outcome graph 114. To generate the outcome graph 114, the processing circuitry 104 may be further configured to create a set of outcome nodes based on the set of primary nodes. The processing circuitry 104 may be further configured to execute the set of rules associated with each of the one or more mapper nodes on a data value associated with an auxiliary node, of the set of auxiliary nodes, linked to the corresponding mapper node. Further, based on the execution, another set of data values may be generated. Further, the processing circuitry 104 may be configured to generate another set of data values based on the execution of the set of rules associated with each of the one or more mapper nodes. The processing circuitry 104 may be configured to populate the set of outcome nodes based on the other set of data values. The processing circuitry 104 may be configured to store the outcome graph 114 in the storage circuitry 106. The outcome graph 114 may be utilized for various real-time operations, for example, trend analysis, anomaly detection, or the like. The structure of the outcome graph 114 is explained in detail in conjunction with FIGS. 2B and 2C.

Thus, the present disclosure provides numerous advantages including optimized and secure ontology mapping. As the primary and auxiliary graphs 110 and 112 are not exposed to the third-party mapper applications, the primary and auxiliary graphs 110 and 112 are prevented from security threats. Additionally, the generated outcome graph 114 may utilized for various real-time operations such as anomaly detection, inference analytics, or the like. Notably, the ontology mapping is performed based on schemas associated with the primary graph 110 and the auxiliary graph 112, therefore, the present disclosure provides real-time ontology mapping with significant ease and reduced time consumption. The real-time ontology mapping may further aid in real-time-analysis of data and the generation of real-time insights.

The processing circuitry 104 may be implemented by one or more processors, such as, but not limited to, an application-specific integrated circuit (ASIC) processor, a reduced instruction set computer (RISC) processor, a complex instruction set computer (CISC) processor, and a field programmable gate array (FPGA) processor. The one or more processors may also correspond to central processing units (CPUs), graphics processing units (GPUs), neural processing units (NPUs), digital signal processors (DSPs), or the like. It will be apparent to a person of ordinary skill in the art that the processing circuitry 104 may be compatible with multiple operating systems. The processing circuitry 104 may further include one or more components (for example, a parser, a loader, or the like) that may be configured to execute one or more operations to be executed by the processing circuitry 104.

The communication network 108 is a medium through which instructions and data are transmitted between the processing circuitry 104 and the storage circuitry 106. Examples of the communication network 108 may include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber-optic network, a coaxial cable network, an infrared (IR) network, a radio frequency (RF) network, microwave communication, and a combination thereof. Examples of the communication network 108 may further include a Narrow Band-Internet of Things (NB-IoT) network, a 5G network, a 4G network, a long-range (LoRa) wireless technology network, a ZigBee network, an IPv6 Low-power Wireless Personal Area Network (6LowPAN), or the like. Various entities (such as the processing circuitry 104 and the storage circuitry 106) in the system environment 100 may be coupled to the communication network 108 in accordance with various wired and wireless communication protocols, such as Transmission Control Protocol and Internet Protocol (TCP/IP), User Datagram Protocol (UDP), Long Term Evolution (LTE) communication protocols, or any combination thereof.

Although the present disclosure describes the generation and utilization of a directed property graph (e.g., the primary graph 110 and the auxiliary graph 112), the scope of the present disclosure is not limited to it. In numerous embodiments, other types of graphs, such as undirected graphs, weighted graphs, bipartite graphs, or the like, may be utilized without deviating from the scope of the present disclosure.

The scope of the present disclosure is not limited to a standalone realization of the storage circuitry 106, as described herein. In numerous embodiments, the storage circuitry 106 can be realized in the form of a database server or a cloud storage working in conjunction with the processing circuitry 104, without departing from the scope of the present disclosure.

FIG. 2A is a schematic diagram 200A that illustrates ontology mapping between a primary graph 202 and an auxiliary graph 204, consistent with disclosed embodiments of the present disclosure. The primary graph 202 and an auxiliary graph 204 may be structurally similar to the primary graph 110 and the auxiliary graph 112, respectively.

The primary graph 202 may be generated by the processing circuitry 104 for a particular domain (for example, IoT, healthcare, or the like). The primary graph 202 may have a unique ontology associated therewith. Further, each domain may be associated with several subdomains each being associated with a unique ontology. The auxiliary graph 204 may be generated by the processing circuitry 104 for a subdomain associated with the primary graph 202. Further, each of the subdomains may correspond to a data source derived from a dataset. The dataset may contain various data fields. Each data field may be associated with various data values. The auxiliary graph 204 may have a unique ontology associated therewith. That is to say, the primary graph 202 is generated for a domain, comprising several subdomains such that for each data value included within the dataset of the subdomain, there may exist a corresponding equivalent data value within the primary graph 202.

The primary graph 202 may comprise a plurality of primary nodes. Further, the plurality of primary nodes may comprise primary data nodes and primary attribute nodes. For example, the primary graph 202 is shown to include primary data nodes 206-212. Each primary data node may correspond to a data value in the primary graph 202. Further, each primary data node may be associated with one or more primary attributes. The primary graph 202 is further shown to include primary attribute nodes 214-224 that represent primary attributes of corresponding primary data nodes. For example, the primary attribute node 214 is associated with the primary data node 206, such that the primary attribute node 214 may represent a primary attribute associated with the primary data node 206. Similarly, the primary attribute nodes 216 and 218 are associated with the primary data node 208, the primary attribute nodes 220 and 222 are associated with the primary data node 210, and the primary attribute node 224 is associated with the primary data node 212.

In an embodiment, the processing circuitry 104 may be configured to determine an abstract attribute for each of the primary data nodes 206-212. The abstract attribute may be indicative of an abstraction status of a primary data node. The abstraction status being true may indicate a conceptual or non-concrete representation of a primary data node in the primary graph 202. That is to say, a primary data node being an abstract node may correspond to a generic node that can be specialized or instantiated into more specific nodes. The abstraction status being false may indicate a concrete, fully defined node that can be instantiated and used directly in the primary graph 202. That is to say, a primary data node being a non-abstract node may have a functional behavior associated therewith. Further, the processing circuitry 104 may be configured to associate the abstract attribute determined for each of the primary data nodes 206-212 as node properties thereof.

The node properties associated with the primary data nodes 206-212 are illustrated in dotted boxes 226-232, respectively. For example, the dotted box 226 is shown to include the abstract attribute in the form of a key-value pair such as abstract (denoted as ‘Ab’ in FIG. 2A): ‘T’. The abstract attribute may be indicative of the abstraction status of the primary data node 206 (e.g., the abstraction of the primary data node 206 being true, denoted as ‘T’ in FIG. 2A, may indicate that the primary data node 206 corresponds to an abstract node). Further, the dotted box 228 associated with the primary data node 208 is shown to include the abstract attribute in the form of key-value pair such as abstract: ‘F’. The abstract attribute may be indicative of the abstraction status of the primary data node 208 (e.g., the abstraction of the primary data node 208 being false, denoted as ‘F’ in FIG. 2A, may indicate that the primary data node 208 corresponds to a non-abstract node). Similarly, the dotted boxes 230 and 232 indicate that the primary data nodes 210 and 212 are abstract and non-abstract nodes, respectively.

Thus, the primary data nodes 206 and 210 may correspond to abstract nodes and the primary data nodes 208 and 212 may correspond to non-abstract nodes in the primary graph 202. In an embodiment, the primary data node 208 and the primary data node 212 extend the primary data node 206 and the primary data node 210, respectively, such that the primary data node 208 and the primary data node 212 may correspond to a concrete implementation of the primary data node 206 and the primary data node 210, respectively.

The primary graph 202 may further include a plurality of mapper nodes. For example, the primary graph 202 is shown to include mapper nodes 234-240. Each of the mapper nodes 234-240 may be configured to store a set of rules. The set of rules may define mapping between the primary graph 202 and the auxiliary graph 204. That is to say, based on the set of rules associated with each of the mapper nodes 234-240, the primary graph 202 may be mapped to the auxiliary graph 204. As described above, each of the primary graph 202 and the auxiliary graph 204 has a unique ontology, and the mapping between the plurality of primary nodes and the plurality of auxiliary nodes corresponds to an ontology mapping between the primary graph 202 and the auxiliary graph 204. Although not labeled in FIG. 2A, the plurality of mapper nodes are linked to the plurality of auxiliary nodes and the plurality of primary nodes by way of edges.

The auxiliary graph 204 may comprise a plurality of auxiliary nodes. Further, the plurality of auxiliary nodes may comprise auxiliary data nodes and auxiliary attribute nodes. For example, the auxiliary graph 204 is shown to include auxiliary data nodes 242 and 244. Each auxiliary data node may correspond to a data value in the auxiliary graph 204. Further, each auxiliary data node may be associated with one or more auxiliary attributes. The auxiliary graph 204 is further shown to include auxiliary attribute nodes 246-252 that represent auxiliary attributes of the corresponding auxiliary data nodes. For example, the auxiliary attribute nodes 246 and 248 are associated with the auxiliary data node 242, such that the auxiliary attribute nodes 246 and 248 may represent auxiliary attributes associated with the auxiliary data node 242. Similarly, the auxiliary attribute nodes 250 and 252 are associated with the auxiliary data node 244.

In an embodiment, the processing circuitry 104 may be configured to determine an abstract attribute for each of the auxiliary data nodes 242 and 244. The abstract attribute may be indicative of an abstraction status of an auxiliary data node. The abstraction status being true may indicate a conceptual or non-concrete representation of an auxiliary data node in the auxiliary graph 204. That is to say, an auxiliary data node being an abstract node may correspond to a generic node that can be specialized or instantiated into more specific nodes. The abstraction status being false may indicate a concrete, fully defined node that can be instantiated and used directly in the auxiliary graph 204. That is to say, an auxiliary data node being a non-abstract node may have a functional behavior associated therewith. Further, the processing circuitry 104 may be configured to associate the abstract attribute determined for each of the auxiliary data nodes 242 and 244 as node properties thereof.

The node properties associated with the auxiliary data nodes 242 and 244 are illustrated in dotted boxes 254 and 256, respectively. For example, the dotted box 254 is shown to include the abstract attribute in the form of a key-value pair such as abstract: ‘T’. The abstract attribute may be indicative of the abstraction status of the auxiliary data node 242 (e.g., the abstraction of the auxiliary data node 242 being true may indicate that the auxiliary data node 242 corresponds to an abstract node). Further, the dotted box 256 associated with the auxiliary data node 244 is shown to include the abstract attribute in the form of key-value pair such as abstract: ‘F’. The abstract attribute may be indicative of the abstraction status of the auxiliary data node 244 (e.g., the abstraction of the auxiliary data node 244 being false may indicate that the auxiliary data node 244 corresponds to a non-abstract node).

In an embodiment, the plurality of mapper nodes (for example, the mapper nodes 234-240) may be configured to map the plurality of primary nodes (for example, the primary data nodes 206-212 and the primary attribute nodes 214-224) and the plurality of auxiliary nodes (for example, the auxiliary data nodes 242 and 244 and the auxiliary attribute nodes 246-252). The plurality of mapper nodes may map the plurality of primary nodes and the plurality of auxiliary nodes such that each mapper node is configured to store a set of rules that define mapping of one or more auxiliary nodes to at least one primary node.

Thus, as illustrated in FIG. 2A, the mapper node 236 may be configured to store a set of rules that define mapping of the auxiliary data node 242 to the primary data nodes 206 and 210. Further, the mapper node 234 may be configured to store a set of rules that define mapping of the auxiliary attribute node 248 to the primary attribute node 214. That is to say, a data value and an attribute in the auxiliary graph 204 are mapped to an equivalent data value and an equivalent attribute, respectively, in the primary graph 202. Similarly, the mapper node 238 may be configured to store a set of rules that define mapping of the auxiliary data node 244 to the primary data nodes 208 and 212. Further, the mapper node 240 may be configured to store a set of rules that define mapping of the auxiliary attribute node 252 to the primary attribute nodes 216 and 224.

As described above, the primary data node 208 extends the primary data node 206, the primary data node 212 extends the primary data node 210, and the auxiliary data node 244 extends the auxiliary data node 242. Thus, as the mapper node 236 maps the auxiliary data node 242 to the primary data nodes 206 and 210 and the mapper node 238 maps the auxiliary data node 244 to the primary data nodes 208 and 212, the mapper node 238 extends the mapper node 236.

In an embodiment, the processing circuitry 104 may be configured to determine, for each mapper node of the plurality of mapper nodes (for example, the mapper nodes 234-240), one or more mapping attributes that indicate the one or more auxiliary nodes that are linked to the corresponding mapper node. The processing circuitry 104 may be further configured to associate the one or more mapping attributes as node properties of the corresponding mapper node (not shown). That is to say, the one or more mapping attributes may indicate the auxiliary node to which the mapper node is linked to. In an embodiment, the one or more mapping attributes associated with the mapper node 234 may indicate that the mapper node 234 is linked to the auxiliary attribute node 248. Similarly, the one or more mapping attributes associated with the mapper node 236 may indicate that the mapper node 236 is linked to the auxiliary data node 242. Further, the one or more mapping attributes associated with the mapper node 238 may indicate that the mapper node 238 is linked to the auxiliary data node 244. Similarly, the one or more mapping attributes associated with the mapper node 240 may indicate that the mapper node 240 is linked to the auxiliary attribute node 252.

Thus, the ontology mapping between the primary graph 202 and the auxiliary graph 204 based on mapping the data values associated with the primary data nodes 206-212 with the data values associated with the auxiliary data nodes 242 and 244, and the attributes associated with the primary attribute nodes 214-224 with the attributes associated with the auxiliary attribute nodes 246-252, may exhibit presence of comprehensive equivalence of data in the primary graph 202 for the data included within the auxiliary graph 204. Thus, ontology mapping performed in the described manner may allow seamless and efficient mapping of a wide variety of data based on the schemas associated with the primary graph 202 and the auxiliary graph 204. Ontology mapping performed in the described manner may further allow flexible mapping of data between the primary graph 202 and the auxiliary graph 204, each having a different ontology that may be utilized in various domains where flexibility of data representation is required. For example, social media platforms, healthcare, finance, or the like.

In an embodiment, the processing circuitry 104 may be configured to receive a stimulus. The stimulus may be indicative of a set of data values associated with the auxiliary graph 204. The processing circuitry 104 may be further configured to identify, based on the stimulus, a set of auxiliary nodes associated with the set of data values. In an embodiment, the processing circuitry 104 may be configured to identify the auxiliary data nodes 242 and 244, the auxiliary attribute node 248, and the auxiliary attribute node 252.

Thus, the identified set of auxiliary nodes may include the auxiliary data nodes 242 and 244 and the auxiliary attribute nodes 248 and 252.

Using the primary graph 202, the processing circuitry 104 may be further configured to identify one or more mapper nodes linked to the set of auxiliary. For example, using the primary graph 202, the processing circuitry 104 may identify the mapper node 234 that is linked to the auxiliary attribute node 248, the mapper node 236 that is linked to the auxiliary data node 242, the mapper node 238 that is linked to the auxiliary data node 244, and the mapper node 240 that is linked to the auxiliary attribute node 252. Thus, the identified one or more mapper nodes may correspond to the mapper nodes 234-240. In some embodiments, the one or more mapper nodes 234-240 may be linked to the set of auxiliary nodes by way of one or more edges, respectively. Based on the identification of the mapper nodes 234-240, the processing circuitry 104 may be further configured to identify, using the primary graph 202, a set of primary nodes, such that each mapper node of the identified mapper nodes is linked to at least one of the set of primary nodes. In some embodiments, each mapper node of the one or more mapper nodes may be linked to at least one of the set of primary nodes by way of an edge. For example, using the primary graph 202, the processing circuitry 104 may identify the primary attribute node 214 that is linked to the mapper node 234, the primary data nodes 206 and 210 that are linked to the mapper node 236, the primary data nodes 208 and 212 that are linked to the mapper node 238, and the primary attribute nodes 216 and 224 that are linked to the mapper node 240.

Thus, the processing circuitry 104 may be configured to identify the primary attribute nodes 214, 216, and 224, and the primary data nodes 206-212. Thus, the identified set of primary nodes may include the primary attribute nodes 214, 216, and 224, and the primary data nodes 206-212.

That is to say, the one or more mapper nodes (for example, the mapper nodes 234-240) map the corresponding auxiliary node, of the set of auxiliary nodes (for example, the auxiliary data nodes 242 and 244 and the auxiliary attribute nodes 248 and 252) to at least one primary node of the set of primary nodes (for example, the primary attribute nodes 214, 216, and 224, and the primary data nodes 206-212). Thus, the mapping between the plurality of primary nodes and the plurality of auxiliary nodes corresponds to an ontology mapping between the primary graph 202 and the auxiliary graph 204.

The processing circuitry 104 may be further configured to execute an operation associated with the stimulus based on at least one of the set of data values, the one or more mapper nodes (for example, the mapper nodes 234-240), or the set of primary nodes (for example, the primary attribute nodes 214, 216, and 224, and the primary data nodes 206-212). To execute the operation associated with the processing circuitry 104 may be further configured to generate an outcome graph based on at least one of the set of data values, the one or more mapper nodes (for example, the mapper nodes 234-240), or the set of primary nodes (for example, the primary attribute nodes 214, 216, and 224, and the primary data nodes 206-212). The outcome graph generated using the primary and auxiliary graphs 202 and 204 is explained in conjunction with FIGS. 2B and 2C.

Although the primary graph 202 and the auxiliary graph 204 are shown to be two separate directed property graphs, the scope of the present disclosure is not limited to it. In numerous embodiments, the primary graph 202 and the auxiliary graph 204 may constitute a single directed property graph.

FIG. 2B is a schematic diagram 200B that illustrates an outcome graph 258, consistent with disclosed embodiments of the present disclosure. In some embodiments, the outcome graph 258 may be structurally similar to the outcome graph 114. The processing circuitry 104 may be further configured to generate the outcome graph 258 to execute the operation associated with the stimulus. To generate the outcome graph 258, the processing circuitry 104 may be further configured to create a set of outcome nodes based on the set of primary nodes (for example, the primary attribute nodes 214, 216, and 224, and the primary data nodes 206-212). In an embodiment, the processing circuitry 104 may be configured to create outcome nodes 260-272. The outcome nodes 260-266 may correspond to the primary data nodes 206-212, respectively, whereas the outcome nodes 268-272 may correspond to the primary attribute nodes 214, 216, and 224, respectively.

The processing circuitry 104 may be further configured to execute the set of rules associated with each of the one or more mapper nodes (for example, the mapper nodes 234-240) on a data value associated with an auxiliary node, of the set of auxiliary nodes (for example, the auxiliary data nodes 242 and 244 and the auxiliary attribute nodes 248 and 252), linked to the corresponding mapper node. As described above, the mapper node 234 is linked with the auxiliary attribute node 248. In such a scenario, the processing circuitry 104 may be further configured to execute the set of rules associated with the mapper node 234 on the data value associated with the auxiliary attribute node 248. Similarly, the processing circuitry 104 may be configured to execute the set of rules associated with the mapper node 236, linked with the auxiliary data node 242, on the data value associated with the auxiliary data node 242. Further, the processing circuitry 104 may be configured to execute the set of rules associated with the mapper node 238, linked with the auxiliary data node 244, on the data value associated with the auxiliary data node 244. Similarly, the processing circuitry 104 may be configured to execute the set of rules associated with the mapper node 240, linked with the auxiliary attribute node 252, on the data value associated with the auxiliary attribute node 252.

The execution of the set of rules associated with the one or more mapper nodes 234-240 on the data values may correspond to mutation of the data values, aggregation of the data values, or the like. The processing circuitry 104 may be further configured to generate another set of data values based on the execution of the set of rules associated with each of the one or more mapper nodes (for example, the mapper nodes 234-240). The processing circuitry 104 may be further configured to populate the set outcome nodes 260-272 based on the other set of data values. For example, the outcome node 268 may be populated based on the set of rules of the mapper node 234 being executed on the data value associated with the auxiliary attribute node 248. Similarly, the outcome nodes 260 and 264 may be populated based on the set of rules of the mapper node 236 being executed on the data value associated with the auxiliary data node 242. Further, the outcome nodes 262 and 266 may be populated based on the set of rules of the mapper node 238 being executed on the data value associated with the auxiliary data node 244. Lastly, the outcome nodes 270 and 272 may be populated based on the set of rules of the mapper node 240 executed on the data value associated with the auxiliary attribute node 252.

The outcome graph 258 thus comprises outcome nodes (e.g., outcome nodes 260-272) that represent the set of data values associated with the stimulus in conformity with an ontology associated with the primary graph 202.

In some embodiments, a populated data value may be generated based on a single data value (e.g., the data value populated in the outcome node 268 may be generated based on the data value associated with the auxiliary attribute node 248). However, the scope of the present disclosure is not limited to it. In several embodiments, a populated data value may be generated based on one or more data values, without deviating from the scope of the present disclosure.

In the outcome graph 258, the set of outcome nodes 260-272 match the set of primary nodes (the primary data nodes 206-212 and the primary attribute nodes 214, 216, and 224, respectively). The scope of the present disclosure is however not limited to it. In several embodiments, at least one primary node, of the set of primary nodes, may be represented as node properties of an outcome node, of the set of outcome nodes, at least one primary node, of the set of primary nodes, may be absent in the set of outcome nodes, or a combination thereof. Such an alternate outcome graph is illustrated in FIG. 2C.

FIG. 2C is a schematic diagram 200C that illustrates another outcome graph 274, consistent with disclosed embodiments of the present disclosure. In some embodiments, the outcome graph 274 may be structurally similar to the outcome graph 114. The outcome graph 274 may be generated in the similar manner as described for the outcome graph 258. However, in the outcome graph 274, the set of outcome nodes may not match the set of primary nodes. For example, in the outcome graph 274, the outcome node 260 that represents the primary data node 206 may be absent. As illustrated in FIG. 2A, the primary attribute node 214 is linked to the primary data node 206, and the primary data node 208 may extend the primary data node 206. Further, the outcome nodes 268 and 262 represent the primary attribute node 214 and the primary data node 208, respectively. Thus, in the absence of the primary data node 206 in outcome graph 274 may result in the outcome node 268 being linked to the outcome node 262.

In some embodiments, in the outcome graph 274, at least one primary node, of the set of primary nodes (for example, the primary attribute nodes 214, 216, and 224, and the primary data nodes 206-212), may be represented as node properties of an outcome node, of the set of outcome nodes 260-272. For example, the outcome node 272 that represents the primary attribute node 224, in the primary graph 202, may be represented as a node property of the outcome node 266. The node property (denoted as ‘AttrValue’ in FIG. 2C) representing the primary attribute node 224 is shown in a dotted box 276 associated with the outcome node 266.

Thus, the outcome graph 274 may correspond to an optimized graph with optimization performed at the node level and the attribute level. Such a graph structure ensures that exclusively the essential nodes are created in the outcome graph 274 (for example, the absence of the outcome nodes 260 based on abstraction). Additionally, the association of the primary attribute node 224 as the node property of the outcome node 266 may aid in efficient memory utilization and faster query processing.

In some embodiments, the processing circuitry 104 may be further configured to store the outcome graphs 258 and 274 in the storage circuitry 106. The outcome graphs 258 and 274 may be utilized for various purposes such as trend analysis, anomaly detection, monitoring historical versioning and snapshotting, inference analytics, or the like.

Although it is described that only one auxiliary graph (for example, the auxiliary graph 204) is mapped to one primary graph (for example, the primary graph 202), the scope of the present disclosure is not limited to it. In several embodiments, multiple auxiliary graphs may be mapped to a single primary graph. In numerous other embodiments, one auxiliary graph may be mapped to another auxiliary graph.

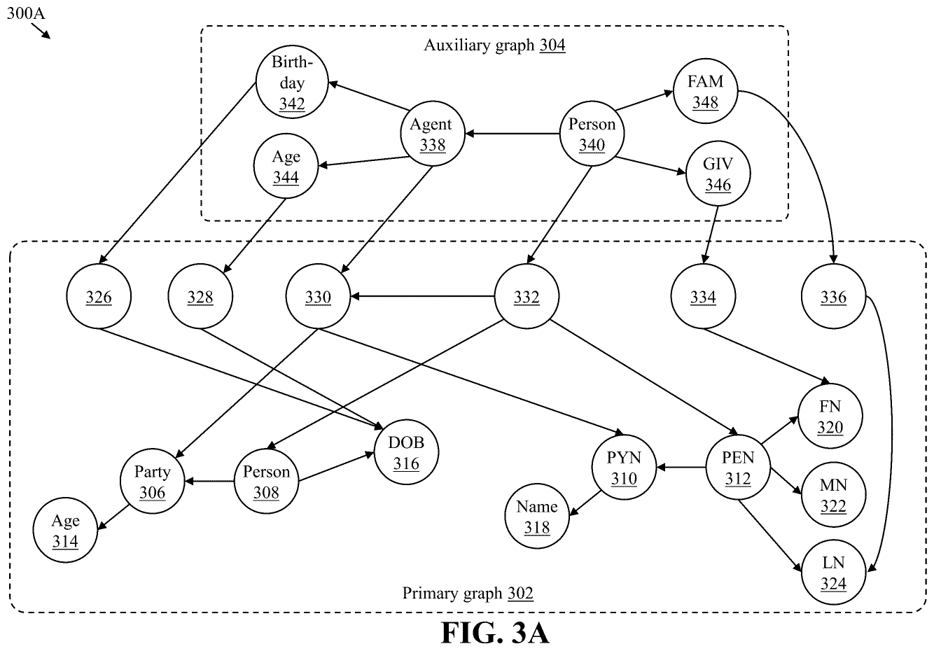

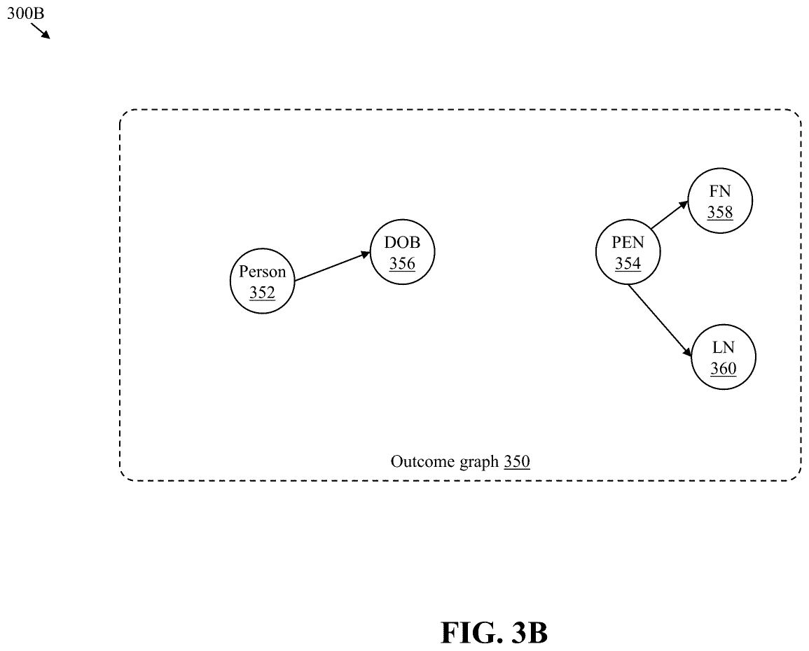

FIGS. 3A and 3B are schematic diagrams 300A and 300B that, collectively, represent an example implementation of ontology mapping using directed property graphs, consistent with disclosed embodiments of the present disclosure.

Referring to FIG. 3A, a primary graph 302 and an auxiliary graph 304 are shown. The primary graph 302 may represent an industry-standard ontology based on parties, whereas the auxiliary graph 304 may correspond to another industry-standard ontology based on agents. The primary graph 302 and the auxiliary graph 304 may be structurally and functionally similar to the primary graph 202 and the auxiliary graph 204, respectively. Each of the primary graph 302 and an auxiliary graph 304 may have a unique ontology associated therewith.

The primary graph 302 is shown to include a plurality of primary nodes. For example, the primary graph 302 is shown to include a party node 306, a person node 308, a party name node 310, a person name node 312, an age node 314, a date of birth node 316, a name node 318, a first name node 320, a middle name node 322, and a last name node 324. In FIGS. 3A and 3B, the party name is denoted as ‘PYN’, the person name is denoted as ‘PEN’, the date of birth is denoted as ‘DOB’, the first name is denoted as ‘FN’, the middle name is denoted as ‘MN’, and the last name is denoted as ‘LN’.

The age node 314 may represent an age attribute associated with the party node 306, whereas the date of birth node 316 may represent a date of birth attribute associated with the person node 308. Similarly, the name node 318 may correspond to a name attribute associated with the party name node 310. Further, the first name node 320, the middle name node 322, and the last name node 324 may correspond to a first name attribute, a middle name attribute, and a last name attribute associated with the person name node 312, respectively. The party node 306, the person node 308, the party name node 310, and the person name node 312 may correspond to primary data nodes in the primary graph 302. Further, the age node 314, the date of birth node 316, the name node 318, the first name node 320, the middle name node 322, and the last name node 324 may correspond to primary attribute nodes in the primary graph 302.

In an embodiment, the party node 306 and the party name node 310 may correspond to an abstract node, whereas the person node 308 and the person name node 312 may correspond to non-abstract nodes such that the person node 308 extends the party node 306 and the person name node 312 extends the party name node 310.

The primary graph 302 is further shown to include a plurality of mapper nodes. For example, the primary graph 302 may include mapper nodes 326-336. Each of the mapper nodes 326-336 may include a set of rules that may define the mapping between the primary graph 302 and the auxiliary graph 304.

The auxiliary graph 304 is shown to include a plurality of auxiliary nodes. For example, the auxiliary graph 304 may include an agent node 338, a person node 340, a birthday node 342, an age node 344, a given name node 346, and a family name node 348. In FIGS. 3A and 3B, the given name is denoted as ‘GIV’, and the family name is denoted as ‘FAM’.

The birthday node 342 and the age node 344 may represent a birthday attribute and an age attribute associated with the agent node 338, respectively. Similarly, the given name node 346 and the family name node 348 may represent a given name attribute and a family name attribute associated with the person node 340, respectively. The agent node 338 and the person node 340 may correspond to the auxiliary data nodes, whereas the birthday node 342, the age node 344, the given name node 346, and the family name node 348 may correspond to auxiliary attribute nodes. In some embodiments, the agent node 338 may correspond to an abstract node and the person node 340 may correspond to a non-abstract node such that the person node 340 extends the agent node 338.

As described previously, each of the plurality of mapper nodes 326-336 may include a set of rules that may define mapping of one or more auxiliary nodes to at least one primary node. In an embodiment, the mapper node 326 may be configured to store a set of rules that may define mapping of the birthday node 342 in the auxiliary graph 304, to the date of birth node 316 in the primary graph 302. Similarly, the mapper node 328 may be configured to store a set of rules that may define mapping of the age node 344 in the auxiliary graph 304, to the data of birth node 316 in the primary graph 302. Further, the mapper node 330 may be configured to store a set of rules that may define mapping of the agent node 338 in the auxiliary graph 304, to the party node 306 and the party name node 310 in the primary graph 302. Further, the mapper node 332 may be configured to store a set of rules that may define mapping of the person node 340 in the auxiliary graph 304, to the person node 308 and the person name node 312 in the primary graph 302. Thus, as the mapper node 330 maps the agent node 338 to the party node 306 and the party name node 310 and the mapper node 332 maps the person node 340 to the person node 308 and the person name node 312, the mapper node 332 extends the mapper node 330. The mapper node 334 may be configured to store a set of rules that may define mapping of the given name node 346 in the auxiliary graph 304, to the first name node 320 in the primary graph 302. Further, the mapper node 336 may be configured to store a set of rules that may define mapping of the family name node 348 in the auxiliary graph 304, to the last name node 324 in the primary graph 302.

In an embodiment, the processing circuitry 104 may be configured to receive a stimulus. The stimulus may be indicative of a set of data values associated with the auxiliary graph 304. In an embodiment, the stimulus may include a data value ‘11-11’ (i.e., in dd-mm format), a data value ‘24’ (i.e., in years), a data value ‘Jim’, and a data value ‘Brown’. The processing circuitry 104 may be further configured to identify, based on the stimulus, using the auxiliary graph 304, the birthday node 342, the age node 344, the given name node 346, and the family name node 348 that are associated with the data value ‘11-11’, the data value ‘24’, the data value ‘Jim’, and the data value ‘Brown’, respectively. Further, the processing circuitry 104 may be configured to identify, using the auxiliary graph 304, the agent node 338 that is associated with the birthday node 342 and the age node 344, and the person node 340 that is associated with the given name node 346 and the family name node 348.

The processing circuitry 104 may be further configured to identify, using the primary graph 302, one or more mapper nodes linked to the identified auxiliary nodes. In an embodiment, the processing circuitry 104 may be configured to identify, the mapper nodes 326-336. Further, based on the identified mapper nodes 326-336, the processing circuitry 104 may be configured to identify, using the primary graph 302, a set of primary nodes linked to the mapper nodes 326-336. For example, based on the mapper nodes 326 and 328, the processing circuitry 104 may identify the date of birth node 316. Similarly, based on the mapper node 330, the processing circuitry 104 may identify the party node 306 and the party name node 310. Similarly, based on the mapper node 332, the processing circuitry 104 may identify the person node 308 and the person name node 312. Based on the mapper node 334, the processing circuitry 104 may identify the first name node 320. Similarly, based on the mapper node 336, the processing circuitry 104 may identify the last name node 324. Thus, the identified set of primary nodes may include the party node 306, the person node 308, the party name node 310, the person name node 312, the date of birth node 316, the first name node 320, and the last name node 324.

The processing circuitry 104 may be further configured to execute an operation associated with the stimulus based on at least one of the set of data values, the one or more mapper nodes (for example, the mapper nodes 326-336), or the set of primary nodes (for example, the party node 306, the person node 308, the party name node 310, the person name node 312, the date of birth node 316, the first name node 320, and the last name node 324). To execute the operation, the processing circuitry 104 may be further configured to generate an outcome graph. The creation and utilization of the outcome graph is explained in detail in conjunction with FIG. 3B.

Referring to FIG. 3B, shown is an outcome graph 350. To generate the outcome graph 350, the processing circuitry 104 may be configured to create a set of outcome nodes based on the set of primary nodes. In an embodiment, the processing circuitry 104 may be configured to create outcome nodes 352-360.

For example, the processing circuitry 104 may create a person node 352 and a person name node 354 based on the person node 308 and the person name node 312, respectively. Further, the processing circuitry 104 may be configured to execute the set of rules associated with each of the one or more mapper nodes on a data value associated with an auxiliary node, of the set of auxiliary nodes, linked to the corresponding mapper node. The processing circuitry 104 may be further configured to generate another set of data values based on the execution of the set of rules associated with each of the one or more mapper nodes.

For example, based on the execution of the set of rules associated with the mapper nodes 326 and 328, the processing circuitry 104 may be configured to determine a data value for the date of birth attribute. In other words, ‘11-11’ which is the data value for the birthday attribute, and ‘24’ which is the data value for the age attribute are retrieved. Further, a data value ‘11-11-1999’ associated with the date of birth attribute in the primary graph 302 is derived by utilizing the data values for the birthday attribute (i.e., ‘11-11’) and the age attribute (i.e., ‘24’) based on the set of rules associated with the mapper node 326 and 328. Thus, a data value, of the other set of data values, is generated based on one or more data values, of the set of data values associated with the stimulus.

The processing circuitry 104 may be further configured to populate the set of outcome nodes based on the other set of data values. For example, the processing circuitry 104 may be configured to populate the outcome node 356 based on the data value ‘11-11-1999’. Similarly, the processing circuitry 104 may be configured to populate the outcome node 358 with the data value ‘Jim’ based on the mapping of the given name node 346 with the first name node 320. Further, the processing circuitry 104 may be configured to populate the outcome node 360 with the data value ‘Brown’ based on the mapping of the family name node 348 with the last name node 324.

Although data values ‘Jim’ and ‘Brown’ are represented as outcome nodes 358 and 360, the scope of the present disclosure is not limited to it. In several other embodiments, the data values ‘Jim’ and ‘Brown’ may be represented as node properties of the outcome node 354, thereby aiding in efficient memory utilization as well as efficient identification of the data values ‘Jim’ and ‘Brown’ based on the requirement thereof.

The processing circuitry 104 may be further configured to store the generated outcome graph 350 in the storage circuitry 106. The generated outcome graph 350 may be utilized for various purposes such as trend analysis, anomaly detection, monitoring historical versioning and snapshotting, inference analytics, or the like.

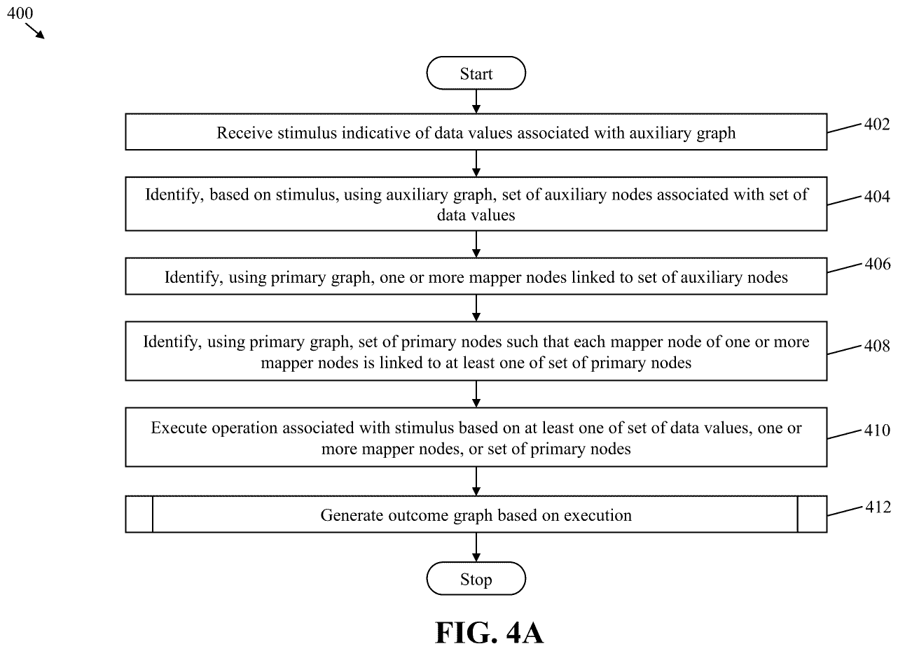

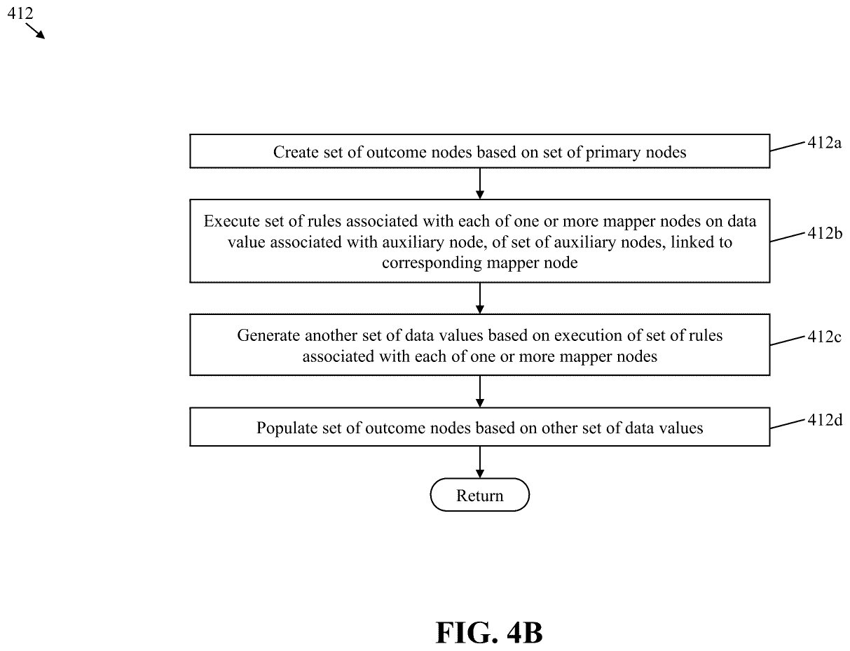

FIGS. 4A and 4B, collectively, represent a flowchart 400 that illustrates a method for facilitating ontology mapping using directed property graphs, consistent with disclosed embodiments of the present disclosure.

Referring to FIG. 4A, at 402, the processing circuitry 104 may receive a stimulus indicative of data values associated with an auxiliary graph (for example, the auxiliary graph 204). At 404, the processing circuitry 104 may identify, based on the stimulus, using the auxiliary graph, a set of auxiliary nodes associated with the set of data values. For example, the processing circuitry 104 may identify the set of auxiliary nodes 242-252. At 406, the processing circuitry 104 may identify, using a primary graph, one or more mapper nodes linked to the set of auxiliary nodes. For example, the processing circuitry 104 may identify, using the primary graph 202, one or more mapper nodes 234-240 linked to the set of auxiliary nodes. At 408, the processing circuitry 104 may identify, using the primary graph, a set of primary nodes such that each mapper node of one or more mapper nodes is linked to at least one of the set of primary nodes. For example, the processing circuitry 104 may identify, the set of primary nodes that may include the primary attribute nodes 214, 216, and 224, and the primary data nodes 206-212. At 410, the processing circuitry 104 may execute an operation associated with the stimulus based on at least one of the set of data values, the one or more mapper nodes, or the set of primary nodes. At 412, the processing circuitry 104 may generate an outcome graph based on the execution of the operation. For example, the processing circuitry 104 may generate the outcome graph 258.

Referring to FIG. 4B, to generate the outcome graph, at 412a, the processing circuitry 104 may create a set of outcome nodes based on the set of primary nodes. For example, the processing circuitry 104 may create the set of outcome nodes 260-272. At 412b, the processing circuitry 104 may execute a set of rules associated with each of the one or more mapper nodes on a data value associated with an auxiliary node, of the set of auxiliary nodes, linked to the corresponding mapper node. For example, the processing circuitry 104 may execute a set of rules associated with the mapper node 234 on a data value associated with the auxiliary attribute node 248, of the set of auxiliary nodes. At 412c, the processing circuitry 104 may generate another set of data values based on the execution of the set of rules associated with each of the one or more mapper nodes. At 412d, the processing circuitry 104 may populate the set of outcome nodes based on the other set of data values. For example, the processing circuitry 104 may populate the set of outcome nodes 260-272 based on the other set of data values.

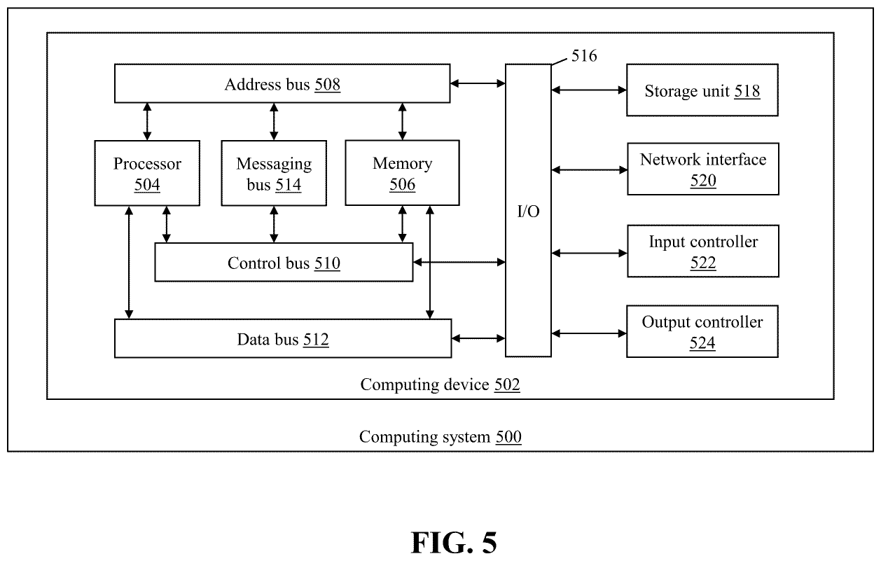

FIG. 5 illustrates an example computing system 500 for carrying out the methods of the present disclosure, consistent with disclosed embodiments of the present disclosure. Specifically, FIG. 5 shows a block diagram of an embodiment of the computing system 500 according to example embodiments of the present disclosure.

The computing system 500 may be configured to perform any of the operations disclosed herein. The computing system 500 can be implemented as a conventional computer system, an embedded controller, a laptop, a server, a mobile device, a smartphone, a set-top box, a kiosk, a vehicular information system, one or more processors associated with a television, a customized machine, any other hardware platform, or any combination or multiplicity thereof. In one embodiment, the computing system 500 is a distributed system configured to function using multiple computing machines interconnected via a data network or bus system.

The computing system 500 includes computing devices (such as a computing device 502). The computing device 502 includes one or more processors (such as a processor 504) and a memory 506. The processor 504 may be any general-purpose processor(s) configured to execute a set of instructions. For example, the processor 504 may be a processor core, a multiprocessor, a reconfigurable processor, a microcontroller, a digital signal processor (DSP), an application-specific integrated circuit (ASIC), a graphics processing unit (GPU), a neural processing unit (NPU), an accelerated processing unit (APU), a brain processing unit (BPU), a data processing unit (DPU), a holographic processing unit (HPU), an intelligent processing unit (IPU), a microprocessor/microcontroller unit (MPU/MCU), a radio processing unit (RPU), a tensor processing unit (TPU), a vector processing unit (VPU), a wearable processing unit (WPU), a field programmable gate array (FPGA), a programmable logic device (PLD), a controller, a state machine, gated logic, discrete hardware component, any other processing unit, or any combination or multiplicity thereof. In one embodiment, the processor 504 may be multiple processing units, a single processing core, multiple processing cores, special purpose processing cores, co-processors, or any combination thereof. The processor 504 may be communicatively coupled to the memory 506 via an address bus 508, a control bus 510, a data bus 512, and a messaging bus 514.

The memory 506 may include non-volatile memories such as a read-only memory (ROM), a programable read-only memory (PROM), an erasable programmable read-only memory (EPROM), a flash memory, or any other device capable of storing program instructions or data with or without applied power. The memory 506 may also include volatile memories, such as a random-access memory (RAM), a static random-access memory (SRAM), a dynamic random-access memory (DRAM), and a synchronous dynamic random-access memory (SDRAM). The memory 506 may include single or multiple memory modules. While the memory 506 is depicted as part of the computing device 502, a person skilled in the art will recognize that the memory 506 can be separate from the computing device 502.

The memory 506 may store information that can be accessed by the processor 504. For instance, the memory 506 (e.g., one or more non-transitory computer-readable storage mediums, memory devices) may include computer-readable instructions (not shown) that can be executed by the processor 504. The computer-readable instructions may be software written in any suitable programming language or may be implemented in hardware. Additionally, or alternatively, the computer-readable instructions may be executed in logically and/or virtually separate threads on the processor 504. For example, the memory 506 may store instructions (not shown) that when executed by the processor 504 cause the processor 504 to perform operations such as any of the operations and functions for which the computing system 500 is configured, as described herein. Additionally, or alternatively, the memory 506 may store data (not shown) that can be obtained, received, accessed, written, manipulated, created, and/or stored. The data can include, for instance, the data and/or information described herein in relation to FIGS. 1-4. In some implementations, the computing device 502 may obtain from and/or store data in one or more memory device(s) that are remote from the computing system 500.

The computing device 502 may further include an input/output (I/O) interface 516 communicatively coupled to the address bus 508, the control bus 510, and the data bus 512. The data bus 512 and messaging bus 514 may include a plurality of tunnels that may support parallel processing of messages. The I/O interface 516 is configured to couple to one or more external devices (e.g., to receive and send data from/to one or more external devices). Such external devices, along with the various internal devices, may also be known as peripheral devices. The I/O interface 516 may include both electrical and physical connections for operably coupling the various peripheral devices to the computing device 502. The I/O interface 516 may be configured to communicate data, addresses, and control signals between the peripheral devices and the computing device 502. The I/O interface 516 may be configured to implement any standard interface, such as a small computer system interface (SCSI), a serial-attached SCSI (SAS), a fiber channel, a peripheral component interconnect (PCI), a PCI express (PCIe), a serial bus, a parallel bus, an advanced technology attachment (ATA), a serial ATA (SATA), a universal serial bus (USB), Thunderbolt, FireWire, various video buses, or the like. The I/O interface 516 is configured to implement only one interface or bus technology. Alternatively, the I/O interface 516 is configured to implement multiple interfaces or bus technologies. The I/O interface 516 may include one or more buffers for buffering transmissions between one or more external devices, internal devices, the computing device 502, or the processor 504. The I/O interface 516 may couple the computing device 502 to various input devices, including mice, touch screens, scanners, biometric readers, electronic digitizers, sensors, receivers, touchpads, trackballs, cameras, microphones, keyboards, any other pointing devices, or any combinations thereof. The I/O interface 516 may couple the computing device 502 to various output devices, including video displays, speakers, printers, projectors, tactile feedback devices, automation control, robotic components, actuators, motors, fans, solenoids, valves, pumps, transmitters, signal emitters, lights, and so forth.

The computing system 500 may further include a storage unit 518, a network interface 520, an input controller 522, and an output controller 524. The storage unit 518, the network interface 520, the input controller 522, and the output controller 524 are communicatively coupled to the central control unit (e.g., the memory 506, the address bus 508, the control bus 510, and the data bus 512) via the I/O interface 516. The network interface 520 communicatively couples the computing system 500 to one or more networks such as wide area networks (WAN), local area networks (LAN), intranets, the Internet, wireless access networks, wired networks, mobile networks, telephone networks, optical networks, or combinations thereof. The network interface 520 may facilitate communication with packet-switched networks or circuit-switched networks which use any topology and may use any communication protocol. Communication links within the network may involve various digital or analog communication media such as fiber optic cables, free-space optics, waveguides, electrical conductors, wireless links, antennas, radio-frequency communications, and so forth.

The storage unit 518 is a computer-readable medium, preferably a non-transitory computer-readable medium, comprising one or more programs, the one or more programs comprising instructions which when executed by the processor 504 cause the computing system 500 to perform the method steps of the present disclosure. Alternatively, the storage unit 518 is a transitory computer-readable medium. The storage unit 518 can include a hard disk, a floppy disk, a compact disc read-only memory (CD-ROM), a digital versatile disc (DVD), a Blu-ray disc, a magnetic tape, a flash memory, another non-volatile memory device, a solid-state drive (SSD), any magnetic storage device, any optical storage device, any electrical storage device, any semiconductor storage device, any physical-based storage device, any other data storage device, or any combination or multiplicity thereof. In one embodiment, the storage unit 518 stores one or more operating systems, application programs, program modules, data, or any other information. The storage unit 518 is part of the computing device 502. Alternatively, the storage unit 518 is part of one or more other computing machines that are in communication with the computing device 502, such as servers, database servers, cloud storage, network attached storage, and so forth.

The input controller 522 may include suitable logic, circuitry, interfaces, and/or code, executable by the circuitry, that may be configured to control one or more input devices that may be configured to receive an input (e.g., the stimulus) generated by the real-time system 102. The output controller 524 may include suitable logic, circuitry, interfaces, and/or code, executable by the circuitry, that may be configured to control one or more output devices that may be configured to render/output the outcome of the operation executed to process the received input.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however, some of the operations may be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the present disclosure provide, among other features, systems, and methods for ontology mapping using directed property graphs. While various embodiments of the disclosed systems and methods have been described above, it should be understood that they have been presented for purposes of example only, and not limitations. It is not exhaustive and does not limit the present disclosure to the precise form disclosed. Modifications and variations are possible in light of the above teachings or may be acquired from practicing the present disclosure, without departing from the breadth or scope.

Moreover, for example, the present technology/system may achieve the following configurations:
1. A system, comprising:
   storage circuitry configured to store (i) a primary graph that comprises a plurality of primary nodes and a plurality of mapper nodes, and (ii) an auxiliary graph that comprises a plurality of auxiliary nodes, where the plurality of mapper nodes is configured to map the plurality of primary nodes and the plurality of auxiliary nodes such that each mapper node is configured to store a set of rules that define mapping of one or more auxiliary nodes to at least one primary node; and
   processing circuitry that is coupled to the storage circuitry, and configured to:
      receive a stimulus indicative of a set of data values associated with the auxiliary graph;
      identify, based on the stimulus, using the auxiliary graph, a set of auxiliary nodes associated with the set of data values;
      identify, using the primary graph, one or more mapper nodes linked to the set of auxiliary nodes;
      identify, using the primary graph, a set of primary nodes, wherein each mapper node of the one or more mapper nodes is linked to at least one of the set of primary nodes; and
      execute an operation associated with the stimulus based on at least one of the set of data values, the one or more mapper nodes, or the set of primary nodes.
2. The system of 1, wherein each of the primary graph and the auxiliary graph has a unique ontology, and wherein the mapping between the plurality of primary nodes and the plurality of auxiliary nodes corresponds to an ontology mapping between the primary graph and the auxiliary graph.
3. The system of 1, wherein to execute the operation associated with the stimulus, the processing circuitry is further configured to generate an outcome graph based on at least one of the set of data values, the one or more mapper nodes, or the set of primary nodes.
4. The system of 3, wherein the processing circuitry is further configured to store the outcome graph in the storage circuitry.
5. The system of 3, wherein the outcome graph comprises one or more outcome nodes that represent the set of data values in conformity with an ontology associated with the primary graph.
6. The system of 3,
   wherein each auxiliary node of the set of auxiliary nodes has a data value of the set of data values associated therewith, and is linked to a mapper node of the one or more mapper nodes, and
   wherein the mapper node maps the corresponding auxiliary node, of the set of auxiliary nodes, to at least one primary node of the set of primary nodes.
7. The system of 3, wherein the outcome graph corresponds to a directed property graph.
8. The system of 3, wherein to generate the outcome graph, the processing circuitry is further configured to:
   create a set of outcome nodes based on the set of primary nodes;
   execute the set of rules associated with each of the one or more mapper nodes on a data value associated with an auxiliary node, of the set of auxiliary nodes, linked to the corresponding mapper node;
   generate another set of data values based on the execution of the set of rules associated with each of the one or more mapper nodes; and
   populate the set of outcome nodes based on the other set of data values.
9. The system of 8, wherein a data value, of the other set of data values, is generated based on one or more data values, of the set of data values.
10. The system of 8, wherein the set of outcome nodes matches the set of primary nodes.
11. The system of 8, wherein at least one primary node, of the set of primary nodes, is represented as node properties of an outcome node, of the set of outcome nodes.
12. The system of 8, wherein at least a first primary node, of the set of primary nodes, is absent in the set of outcome nodes.
13. The system of 12,
   wherein one or more primary nodes, of the set of primary nodes, are linked to the first primary node, and a second primary node, of the set of primary nodes, extends the first primary node,
   wherein the set of outcome nodes comprises (i) one or more outcome nodes that match the one or more primary nodes, respectively, and (ii) an outcome node that matches the second primary node, and
   wherein the absence of the first primary node in the set of outcome nodes results in the one or more outcome nodes being linked to the outcome node.
14. The system of 1, wherein the one or more mapper nodes are linked to the set of auxiliary nodes by way of one or more edges, respectively, and wherein each mapper node of the one or more mapper nodes is linked to at least one of the set of primary nodes by way of an edge.
15. The system of 1,
   wherein the set of primary nodes comprises a first primary data node,
   wherein the set of auxiliary nodes comprises a first auxiliary data node, and
   wherein the one or more mapper nodes comprise a first mapper node that is configured to store a first set of rules that define mapping of the first auxiliary data node to the first primary data node.
16. The system of 15,
   wherein the set of primary nodes further comprises a second primary data node that extends the first primary data node,
   wherein the set of auxiliary nodes further comprises a second auxiliary data node that extends the first auxiliary data node,
   wherein the one or more mapper nodes further comprise a second mapper node that is configured to store a second set of rules that define mapping of the second auxiliary data node to the second primary data node, and
   wherein the second mapper node extends the first mapper node.
17. The system of 15,
   wherein the set of primary nodes further comprises a first primary attribute node, with the first primary data node being associated with the first primary attribute node that represents a first primary attribute of the first primary data node,
   wherein the set of auxiliary nodes further comprises a first auxiliary attribute node, with the first auxiliary data node being associated with the first auxiliary attribute node that represents a first auxiliary attribute of the first auxiliary data node, and
   wherein the one or more mapper nodes further comprise a third mapper node that is configured to store a third set of rules that define mapping of the first auxiliary attribute node to the first primary attribute node.
18. The system of 1, wherein each of the primary graph and the auxiliary graph corresponds to a directed property graph.
19. The system of 1, wherein the primary graph and the auxiliary graph constitute a directed property graph.
20. The system of 1,
   wherein the processing circuitry is further configured to (i) generate the primary graph and the auxiliary graph and (ii) store the primary graph and the auxiliary graph in the storage circuitry,
   wherein to generate the auxiliary graph, the processing circuitry is further configured to create the plurality of auxiliary nodes,
   wherein to generate the primary graph, the processing circuitry is further configured to create the plurality of primary nodes and the plurality of mapper nodes, and
   wherein the processing circuitry is further configured to link the plurality of primary nodes, the plurality of mapper nodes, and the plurality of auxiliary nodes by way of a plurality of edges.
21. The system of 1, wherein the processing circuitry is further configured to:
   determine, for each mapper node of the plurality of mapper nodes, one or more mapping attributes that indicate the one or more auxiliary nodes that are linked to the corresponding mapper node; and
   associate the one or more mapping attributes as node properties of the corresponding mapper node.
22. The system of 1, wherein the processing circuitry is further configured to:
   determine, for a node, an abstract attribute indicative of an abstraction status of the corresponding node, wherein the node corresponds to one of (i) a primary node of the plurality of primary nodes and (ii) an auxiliary node of the plurality of auxiliary nodes; and
   associate the abstract attribute as node properties of the corresponding node.
23. A method, comprising:
   receiving, by processing circuitry, a stimulus,
      wherein a primary graph comprises a plurality of primary nodes and a plurality of mapper nodes,
      wherein an auxiliary graph comprises a plurality of auxiliary nodes,
      wherein the plurality of primary nodes and the plurality of auxiliary nodes are mapped by way of the plurality of mapper nodes such that a set of rules stored in each mapper node, of the plurality of mapper nodes, define mapping of one or more auxiliary nodes, of the plurality of auxiliary nodes, to at least one primary node, of the plurality of primary nodes, and
      wherein the stimulus is indicative of a set of data values associated with the auxiliary graph;
   identifying, by the processing circuitry, based on the stimulus, using the auxiliary graph, a set of auxiliary nodes associated with the set of data values;
   identifying, by the processing circuitry, using the primary graph, one or more mapper nodes linked to the set of auxiliary nodes;
   identifying, by the processing circuitry, using the primary graph, a set of primary nodes, wherein each mapper node of the one or more mapper nodes is linked to at least one of the set of primary nodes; and
   executing, by the processing circuitry, an operation associated with the stimulus based on at least one of the set of data values, the one or more mapper nodes, or the set of primary nodes.

1. A system, comprising:
storage circuitry configured to store (i) a primary graph that comprises a plurality of primary nodes and a plurality of mapper nodes, and (ii) an auxiliary graph that comprises a plurality of auxiliary nodes, where the plurality of mapper nodes is configured to map the plurality of primary nodes and the plurality of auxiliary nodes such that each mapper node is configured to store a set of rules that define mapping of one or more auxiliary nodes to at least one primary node; and
processing circuitry that is coupled to the storage circuitry, and configured to:
receive a stimulus indicative of a set of data values associated with the auxiliary graph;
identify, based on the stimulus, using the auxiliary graph, a set of auxiliary nodes associated with the set of data values;
identify, using the primary graph, one or more mapper nodes linked to the set of auxiliary nodes;
identify, using the primary graph, a set of primary nodes, wherein each mapper node of the one or more mapper nodes is linked to at least one of the set of primary nodes; and
execute an operation associated with the stimulus based on at least one of the set of data values, the one or more mapper nodes, or the set of primary nodes.

2. The system of claim 1, wherein each of the primary graph and the auxiliary graph has a unique ontology, and wherein the mapping between the plurality of primary nodes and the plurality of auxiliary nodes corresponds to an ontology mapping between the primary graph and the auxiliary graph.

3. The system of claim 1, wherein to execute the operation associated with the stimulus, the processing circuitry is further configured to generate an outcome graph based on at least one of the set of data values, the one or more mapper nodes, or the set of primary nodes.

4. The system of claim 3, wherein the processing circuitry is further configured to store the outcome graph in the storage circuitry.

5. The system of claim 3, wherein the outcome graph comprises one or more outcome nodes that represent the set of data values in conformity with an ontology associated with the primary graph.

6. The system of claim 3,
wherein each auxiliary node of the set of auxiliary nodes has a data value of the set of data values associated therewith, and is linked to a mapper node of the one or more mapper nodes, and
wherein the mapper node maps the corresponding auxiliary node, of the set of auxiliary nodes, to at least one primary node of the set of primary nodes.

7. The system of claim 3, wherein the outcome graph corresponds to a directed property graph.

8. The system of claim 3, wherein to generate the outcome graph, the processing circuitry is further configured to:
create a set of outcome nodes based on the set of primary nodes;
execute the set of rules associated with each of the one or more mapper nodes on a data value associated with an auxiliary node, of the set of auxiliary nodes, linked to the corresponding mapper node;
generate another set of data values based on the execution of the set of rules associated with each of the one or more mapper nodes; and
populate the set of outcome nodes based on the other set of data values.

9. The system of claim 8, wherein a data value, of the other set of data values, is generated based on one or more data values, of the set of data values.

10. The system of claim 8, wherein the set of outcome nodes matches the set of primary nodes.

11. The system of claim 8, wherein at least one primary node, of the set of primary nodes, is represented as node properties of an outcome node, of the set of outcome nodes.

12. The system of claim 8, wherein at least a first primary node, of the set of primary nodes, is absent in the set of outcome nodes.

13. The system of claim 12,
wherein one or more primary nodes, of the set of primary nodes, are linked to the first primary node, and a second primary node, of the set of primary nodes, extends the first primary node,
wherein the set of outcome nodes comprises (i) one or more outcome nodes that match the one or more primary nodes, respectively, and (ii) an outcome node that matches the second primary node, and
wherein the absence of the first primary node in the set of outcome nodes results in the one or more outcome nodes being linked to the outcome node.

14. The system of claim 1,
wherein the set of primary nodes comprises a first primary data node,
wherein the set of auxiliary nodes comprises a first auxiliary data node, and
wherein the one or more mapper nodes comprise a first mapper node that is configured to store a first set of rules that define mapping of the first auxiliary data node to the first primary data node.

15. The system of claim 14,
wherein the set of primary nodes further comprises a second primary data node that extends the first primary data node,
wherein the set of auxiliary nodes further comprises a second auxiliary data node that extends the first auxiliary data node,
wherein the one or more mapper nodes further comprise a second mapper node that is configured to store a second set of rules that define mapping of the second auxiliary data node to the second primary data node, and
wherein the second mapper node extends the first mapper node.

16. The system of claim 14,
wherein the set of primary nodes further comprises a first primary attribute node, with the first primary data node being associated with the first primary attribute node that represents a first primary attribute of the first primary data node,
wherein the set of auxiliary nodes further comprises a first auxiliary attribute node, with the first auxiliary data node being associated with the first auxiliary attribute node that represents a first auxiliary attribute of the first auxiliary data node, and
wherein the one or more mapper nodes further comprise a third mapper node that is configured to store a third set of rules that define mapping of the first auxiliary attribute node to the first primary attribute node.

17. The system of claim 1, wherein each of the primary graph and the auxiliary graph corresponds to a directed property graph.

18. The system of claim 1, wherein the primary graph and the auxiliary graph constitute a directed property graph.

19. The system of claim 1, wherein the processing circuitry is further configured to:
determine, for each mapper node of the plurality of mapper nodes, one or more mapping attributes that indicate the one or more auxiliary nodes that are linked to the corresponding mapper node; and
associate the one or more mapping attributes as node properties of the corresponding mapper node.

20. A method, comprising:
receiving, by processing circuitry, a stimulus,
wherein a primary graph comprises a plurality of primary nodes and a plurality of mapper nodes,
wherein an auxiliary graph comprises a plurality of auxiliary nodes,
wherein the plurality of primary nodes and the plurality of auxiliary nodes are mapped by way of the plurality of mapper nodes such that a set of rules stored in each mapper node, of the plurality of mapper nodes, define mapping of one or more auxiliary nodes, of the plurality of auxiliary nodes, to at least one primary node, of the plurality of primary nodes, and
wherein the stimulus is indicative of a set of data values associated with the auxiliary graph;
identifying, by the processing circuitry, based on the stimulus, using the auxiliary graph, a set of auxiliary nodes associated with the set of data values;
identifying, by the processing circuitry, using the primary graph, one or more mapper nodes linked to the set of auxiliary nodes;
identifying, by the processing circuitry, using the primary graph, a set of primary nodes, wherein each mapper node of the one or more mapper nodes is linked to at least one of the set of primary nodes; and
executing, by the processing circuitry, an operation associated with the stimulus based on at least one of the set of data values, the one or more mapper nodes, or the set of primary nodes.
